(19) United States
(12) Patent Application Publication
(10) Pub. No.: US 2026/0323778 A1
(43) Pub. Date: Oct. 15, 2026

(54) Heating Unit and Method for Manufacturing Same

(71) Applicant: LOTTE CHEMICAL CORPORATION, Seoul (KR)

(72) Inventors: Yang Il KIM, Uiwang-si (KR); Chan Moo PARK, Uiwang-si (KR); Young Sub JIN, Uiwang-si (KR); Sang Hwa LEE, Uiwang-si (KR)

(21) Appl. No.: 19/480,917

(22) PCT Filed: Mar. 20, 2024
(86) PCT No.: PCT/KR2024/095593

§ 371 Date: Nov. 3, 2025

(30) Foreign Application Priority Data
May 24, 2023 (KR) 10-2023-0067168

(51) Int. Cl. H05B 3/03

(52) U.S. Cl. CPC H05B 3/03

(57) ABSTRACT

A heating unit of the present invention comprises: a substrate formed from a thermoplastic resin composition including about 100 parts by weight of a polyaryletherketone resin and about 1-20 parts by weight of an additive for laser direct structuring; and a plating layer formed on at least a partial area of the surface of the substrate by a laser direct structuring process and a plating process, wherein the plating layer is a laminate of a copper plating layer and a nickel plating layer, the plating layer has a cross-sectional thickness of about 100-1,000 μm, and a ratio of the cross-sectional thickness of the copper plating layer to the cross-sectional thickness of the nickel plating layer is about 1:1-1:80. The heating unit has excellent heating performance, plating reliability, and the like.

### TECHNICAL FIELD

The present invention relates to a heating unit and a method for manufacturing the same. More specifically, the present invention relates to a heating unit having good heat generation performance, plating reliability, and the like, and a method for manufacturing the same.

### Background Art

A laser direct structuring (LDS) process may be used to form a metal layer in at least a region on a surface of a molded product produced from a thermoplastic resin composition. The LDS process is a pretreatment method for modifying a plating target region on the surface of the molded product to have suitable properties for plating by irradiating the plating target region with laser beams. To this end, a thermoplastic resin composition is required to contain an additive for laser direct structuring (LDS additive), which can form metal nuclei upon irradiation with laser beams. The LDS additive is decomposed to generate metal nuclei upon irradiation with the laser beams. In addition, a region irradiated with the laser beams has a roughened surface. Due to such metal nuclei and surface roughness, the laser-modified region becomes suitable for plating.

An electronic cigarette is an atomizing device that forms water vapor through vaporization of a liquid by applying heat to the liquid, and includes a vaporizing unit adapted to vaporize the liquid. The vaporizing unit is a heating unit configured to heat and vaporize the liquid when electric power is applied thereto, and is usually manufactured in the form of a metal coil, such as copper, wound inside or outside a plastic cylinder. The vaporizing unit (heating coil unit) including a metal coil has a maximum temperature of about 250 ° C. and an operation time of about 4 minutes including a warm-up time of about 30 seconds to reach the maximum temperature.

In recent years, research has delved into manufacture of a heating unit through a metal plating process using a laser direct structuring process instead of metal coils. In order to allow the heating unit manufactured by the plating process to be used as a heating unit for electronic cigarettes, the heating unit is required to have good heat generation performance including a warm-up time of 100 seconds or less to reach 150 ° C., good plating reliability, and the like.

Therefore, there is a need for development of a heating unit with good heat generation performance, plating reliability, and the like, and a method for manufacturing the same.

The background technique of the present invention is disclosed in Korean Patent Laid-open Publication No. 10-2011-0018319 and the like.

### Disclosure

### Technical Problem

It is one object of the present invention to provide a heating unit having good heat generation performance, plating reliability, and the like.

It is another object of the present invention to provide a method for manufacturing the same.

The above and other objects of the present invention can be achieved by embodiments of the present invention described below.

### Technical Solution

1. One aspect of the present invention relates to a heating unit. The heating unit includes: a substrate formed of a thermoplastic resin composition comprising about 100 parts by weight of a polyaryletherketone resin and about 1 part by weight to about 20 parts by weight of an additive for laser direct structuring; and a plating layer formed by a laser direct structuring process and a plating process in at least a region on a surface of the substrate, wherein the plating layer is a stack of a copper plating layer and a nickel plating layer and has a cross-sectional thickness of about 100 μm to about 1,000 μm and a cross-sectional thickness ratio of the copper plating layer to the nickel plating layer in the range of about 1:1 to about 1:80.

2. In embodiment 1, the polyaryletherketone resin may comprise a repeat unit represented by Formula 1.

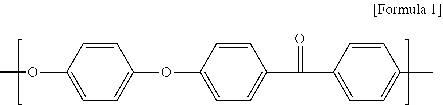

3. In embodiment 1 or 2, the polyaryletherketone resin may have a melt viscosity of about 50 Pa's to about 500 Pa's, as measured by a capillary viscometer at a temperature of 400 ° C. and at a shear rate of 1,000 sec⁻¹ in accordance with ASTM D3835.

4. In embodiments 1 to 3, the additive for laser directed structuring may comprise at least one of a heavy metal complex oxide spinel and a copper salt.

5. In embodiments 1 to 4, the plating process may include a copper electroless plating step, a copper electroplating step, and a nickel electroplating step.

6. In embodiments 1 to 5, the plating process may include a nickel electroless plating step, a nickel electroplating step, and a copper electroplating step.

7. In embodiments 1 to 6, the plating layer may have a maximum temperature of about 200 ° C. to about 300 ° C. upon application of a current of 20 A and a voltage of 10 V, as measured by a thermal imaging camera.

8. In embodiments 1 to 7, the plating layer may have a time of about 1 second to about 100 seconds to reach 150 ° C. upon application of a current of 20 A and a voltage of 10 V, as measured by a thermal imaging camera.

9. In embodiments 1 to 8, the thermoplastic resin composition may have about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber under conditions of 85° C. and 85% RH (relative humidity) for 72 hours, and forming 100 grids each having a size of 1 mm×1 mm on the plating layer.

10. In embodiments 1 to 9, the thermoplastic resin composition may have about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber at 250 ° C. for 200 hours, and forming 100 grids each having a size of 1 mm×1 mm on the plating layer (copper layer).

11. Another aspect of the present invention relates to a method for manufacturing a heating unit. The method comprises: manufacturing a substrate from a thermoplastic resin composition comprising about 100 parts by weight of a polyaryletherketone resin and about 1 part by weight to about 20 parts by weight of an additive for laser direct structuring; irradiating at least a region on a surface of the substrate with laser beams; performing copper or nickel electroless plating over the region irradiated with the laser beams; performing copper or nickel electroplating over the region subjected to copper or nickel electroless plating; and performing nickel or copper electroplating over the region subjected to copper or nickel electroplating to form a plating layer, wherein the plating layer is a stack of a copper plating layer and a nickel plating layer and has a cross-sectional thickness of about 100 μm to about 1,000 μm and a cross-sectional thickness ratio of the copper plating layer to the nickel plating layer in the range of about 1:1 to about 1:80.

12. In embodiment 11, the substrate may be manufactured by injection molding of the thermoplastic composition using an injection molding machine under conditions of a molding temperature of about 380 ° C. to about 480 ° C. and a mold temperature of about 50 ° C. to about 200 ° C.

13. In embodiment 11 or 12, the laser beams may have a wavelength of 248 nm, 308 nm, 355 nm, 532 nm, 1,064 nm, or 10,600 nm.

14. In embodiments 11 to 13, the copper electroless plating may be performed in an copper electroless plating solution at a temperature of about 55° C. for about 10 min to about 40 min, and the nickel electroless plating may be performed in a nickel electroless plating solution at a temperature of about 50 ° C. for about 10 min to about 40 min.

15. In embodiments 11 to 14, the copper electroplating may be performed at a current density of about 10 A/dm² for about 1 min to about 3,000 min, and the nickel electroplating may be performed at a current density of about 5 A/dm² for about 1 min to about 3,000 min.

### Advantageous Effects

The present invention provides a heating unit having good heat generation performance, plating reliability, and the like, and a method for manufacturing the same.

### DESCRIPTION OF DRAWINGS

FIG. 1 is a schematic view of a heating unit according to one embodiment of the present invention.

### BEST MODE

Hereinafter, exemplary embodiments of the present invention will be described in detail.

A heating unit according to the present invention includes (A) a substrate formed of a thermoplastic resin composition; and (B) a plating layer.

As used herein to represent a specific numerical range, “a to b” is defined as “≥a and ≤b”.

### (A) Substrate

The substrate according to one embodiment of the invention is formed of a thermoplastic resin composition for a laser direct structuring process (LDS process), wherein the thermoplastic resin composition comprises (a) a polyaryletherketone resin and (b) an additive for laser direct structuring.

### (a) Polyaryletherketone Resin

The polyaryletherketone resin according to one embodiment of the invention is capable of improving plating reliability, heat resistance, and the like of the heating unit and may be selected from among polyaryletherketone resins used in typical thermoplastic resin compositions.

In some embodiments, a polyaryletherketone resin (polyetheretherketone resin) including a repeat unit represented by Formula 1 may be used.

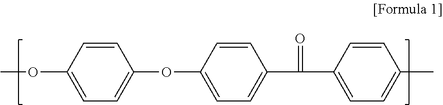

In some embodiments, the polyaryletherketone resin may have a melt viscosity of about 50 Pas to about 500 Pa's, for example, about 100 Pas to about 400 Pa's, as measured by a capillary viscometer at a temperature of 400 ° C. and at a shear rate of 1,000 sec⁻¹ in accordance with ASTM D3835. Within this range, the heating unit can exhibit good plating reliability, heat resistance, and the like.

### (b) Additive for Laser Direct Structuring

The additive for laser direct structuring (LDS additive) according to one embodiment of the invention forms metal nuclei upon irradiation with laser beams and may include any LDS additive used in typical resin compositions for LDS. Here, the laser beam means light amplified through stimulated emission (stimulated emission light) and may be ultraviolet light having a wavelength of 100 nm to 400 nm, visible light having a wavelength of 400 nm to 800 nm, or infrared light having a wavelength of 800 nm to 25,000 nm, for example, infrared light having a wavelength of 1,000 nm to 2,000 nm.

In some embodiments, the LDS additive may include a heavy metal composite oxide spinel and/or a copper salt.

In some embodiments, the heavy metal composite oxide spinel may include magnesium aluminum oxide (MgAl₂O₄), zinc aluminum oxide (ZnAl₂O₄), iron aluminum oxide (FeAl₂O₄), copper iron oxide (CuFe₂O₄), copper chromium oxide (CuCr₂O₄), manganese iron oxide (MnFe₂O₄), nickel iron oxide (NiFe₂O₄), titanium iron oxide (TiFe₂O₄), iron chromium oxide (FeCr₂O₄), magnesium chromium oxide (MgCr₂O₄), and combinations thereof. For example, the heavy metal complex oxide spinel may be copper chromium oxide (CuCr₂O₄). The copper chromium oxide (CuCr₂O₄) has a dark color and thus is advantageous when a final molded product is required to be black or grey.

In some embodiments, the copper salt may include copper hydroxide phosphate, copper phosphate, copper sulfate, cuprous thiocyanate, and combinations thereof, without being limited thereto. For example, the copper salt may be copper hydroxide phosphate. The copper hydroxide phosphate is a compound in which copper phosphate is combined with copper hydroxide, and may include Cu₃(PO₄)₂·2Cu(OH)₂, Cu₃(PO₄)₂·Cu(OH)₂, and the like. The copper hydroxide phosphate does not affect color-reproduction properties of a colorant, as an additive, and thus allows a molded product having a desired color to be easily obtained.

In some embodiments, the LDS additive may have an average particle diameter of about 0.01 μm to about 50 μm, for example, about 0.1 μm to about 30 μm, specifically about 0.5 μm to about 10 μm. Within this range, the LDS additive enables formation of a uniform coating surface through laser direct structuring. As used herein, unless otherwise specifically stated, “average particle diameter” refers to D50 (a diameter at a distribution rate of 50%) which is a number average particle diameter.

In some embodiments, the LDS additive may be present in an amount of about 1 part by weight to about 20 parts by weight, for example, about 5 parts by weight to about 15 parts by weight, relative to about 100 parts by weight of the polyaryletherketone resin. If the content of the LDS additive is less than about 1 part by weight relative to about 100 parts by weight of the polyaryletherketone resin, an insufficient number of metal nuclei is formed in the coating during irradiation of the thermoplastic resin composition (substrate) with laser beams, thereby causing deterioration in plating adhesion and the like, and if the content of the LDS additive exceeds about 20 parts by weight, the thermoplastic resin composition (substrate) can suffer from deterioration in plating reliability, mechanical properties, and the like.

In some embodiments, the thermoplastic resin composition may further include any additives commonly used in typical thermoplastic resin compositions. Examples of the additives may include inorganic fillers, flame retardants, anti-dripping agents, lubricants, nucleating agents, stabilizers, release agents, pigments, dyes, mixtures thereof, and the like, without being limited thereto. The additives may be present in an amount of about 0.001 parts by weight to about 40 parts by weight, for example, about 0.1 parts by weight to about 10 parts by weight, relative to about 100 parts by weight of the polyaryletherketone resin.

According to one embodiment, the thermoplastic resin composition may be prepared in pellet form by mixing the above components, followed by melt extrusion of the mixture in a typical twin-screw extruder at about 360 ° C. to about 420 ° C., for example, about 380 ° C. to about 410 ° C.

In some embodiments, the thermoplastic resin composition may have about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber under conditions of 85° C. and 85% RH (relative humidity) for 72 hours, and forming 100 grids each having a size of 1 mm×1 mm on the plating layer.

In some embodiments, the thermoplastic resin composition may have about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber at 250 ° C. for 200 hours, and forming 100 grids each having a size of 1 mm×1 mm on the plating layer (copper layer).

The substrate according to the present invention is formed of the thermoplastic resin composition as set forth above. For example, the substrate may be prepared by any suitable molding method, such as injection molding, compression molding, blow molding, extrusion molding, and the like, using the thermoplastic resin composition. The substrate can be easily formed by a person having ordinary knowledge in the art.

### (B) Plating Layer

The plating layer according to one embodiment of the invention is a stack of a copper plating layer and a nickel plating layer formed by a laser direct structuring process and a plating process in at least a region on a surface of the substrate. The plating layer may have a cross-sectional thickness of about 100 μm to about 1,000 μm and a cross-sectional thickness ratio of the copper plating layer to the nickel plating layer in the range of about 1:1 to about 1:80.

In some embodiments, the plating process may include a copper electroless plating step, a copper electroplating step, and a nickel electroplating step. In this embodiment, a plating layer may be obtained in the form of a stack of a copper plating layer and a nickel plating layer sequentially stacked in a region on the surface of the substrate.

In some embodiments, the plating process may include a nickel electroless plating step, a nickel electroplating step, and a copper electroplating step. In this embodiment, the plating layer may be obtained in the form of a stack of a nickel plating layer and a copper plating layer sequentially stacked in a region on the substrate surface.

In some embodiments, the plating layer may have a cross-sectional thickness of about 100 μm to about 1,000 μm, for example, about 100 μm to about 700 μm, as measured by SEM/EDS (scanning electron microscopy/energy dispersive spectroscopy). If the cross-sectional thickness of the plating layer is less than about 100 μm, there is a possibility of deterioration in plating reliability, and the like, and if the cross-sectional thickness ratio of the plating layer exceeds about 1,000 μm, there is a possibility of deterioration in heat generation performance, and the like.

In some embodiments, the plating layer may have a cross-sectional thickness ratio of the copper plating layer to the nickel plating layer (copper plating layer: nickel plating layer) in the range of about 1:1 to about 1:80, for example, about 1:1.1 to about 1:50, as measured by SEM/EDS (scanning electron microscopy/energy dispersive spectroscopy). If the cross-sectional thickness ratio of the plating layer is less than about 1:1, there is a possibility of deterioration in heat generation performance, plating reliability, and the like, and if the cross-sectional thickness ratio of the plating layer exceeds about 1:80, there is a possibility of deterioration in heat generation performance and the like.

In some embodiments, the plating layer may have a maximum temperature of about 200 ° C. to about 300 ° C., for example, about 230 ° C. to about 280 ° C. upon application of a current of 20 A and a voltage of 10 V, as measured by a thermal imaging camera.

In some embodiments, the plating layer may have a time of about 1 second to about 100 seconds, for example, about 5 seconds to about 60 seconds, to reach 150 ° C. upon application of a current of 20 A and a voltage of 10 V, as measured by a thermal imaging camera.

The heating unit including the substrate and the plating layer according to the embodiment of the invention has good heat generation performance, plating reliability, and the like, and can thus be used as a vaporizing unit (heating unit) of an electronic cigarette, an induction internal circuit, and the like. In particular, when the heating unit is used as the vaporizing unit of an electronic cigarette, the substrate may have a cylindrical shape and the plating layer may be formed in a coil-like pattern on the inside or outside of the cylindrical substrate.

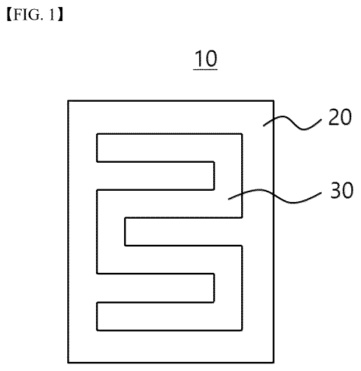

FIG. 1 is a schematic view of a heating unit according to one embodiment of the present invention. It should be understood that the dimensions of components constituting the invention are exaggerated for clarity of description and are not intended to be limiting. Referring to FIG. 1, a heating unit 10 according to one embodiment may include a substrate 20; and a plating layer 30 formed by a laser direct structuring process and a plating process in at least a region on a surface of the substrate 20.

The heating unit 10 according to the embodiment may be formed by a manufacturing method including the steps of: manufacturing a substrate 20 from a thermoplastic resin composition; irradiating at least a region on a surface of the substrate 20 (region corresponding to a plating layer 30) with laser beams; performing copper or nickel electroless plating over the region irradiated with the laser beams; performing copper or nickel electroplating over the region subjected to copper or nickel electroless plating; and performing nickel or copper electroplating over the region subjected to copper or nickel electroplating to form the plating layer 30.

In some embodiments, the substrate 20 may be manufactured by injection molding of the thermoplastic resin composition using an injection molding machine at a molding temperature of about 380 ° C. to about 480 ° C. and a mold temperature of about 50 ° C. to about 200 ° C.

In some embodiments, the additive for laser directly structuring contained in the substrate 20 is decomposed to produce metal nuclei by irradiation with the laser beams. Furthermore, the region irradiated with the laser beams (region corresponding to the plating layer 30) has a surface roughness suitable for plating. The laser beams may have a wavelength of 248 nm, 308 nm, 355 nm, 532 nm, 1,064 nm, or 10,600 nm.

In some embodiments, the process of copper or nickel electroless plating (metallization) may be performed through a typical electroless plating process. For example, the substrate irradiated with the laser beams may be dipped in at least one electroless plating bath to form a copper or nickel electroless plating layer in the laser beam-irradiated region (region corresponding to the plating layer 30) on the surface of the substrate 20.

In some embodiments, the process of copper or nickel electroplating (metallization) and the process of nickel or copper electroplating may be performed through typical electroplating processes. For example, the substrate 20 subjected to copper or nickel electroless plating may be dipped in at least one electroplating bath to form a copper or nickel electroplating layer on a copper or nickel electroless plating layer through copper or nickel electroplating, and nickel or copper electroplating may be performed on the copper or nickel electroplating layer, thereby finally forming the plating layer 30 in the laser beam-irradiated region on the surface of the substrate 20.

In some embodiments, the copper electroless plating may be performed in a copper electroless plating solution (for example, Circuposit 4500) at about 55° C. for about 10 min to about 40 min, and the nickel electroless plating may be performed in a nickel electroless plating solution (for example, Ronamax SMT-115) at about 50 ° C. for about 10 min to about 40 min.

In some embodiments, the copper electroplating may be performed at a current density of about 10 A/dm² for about 1 min to about 3,000 min and the nickel electroplating may be performed at a current density of about 5 A/dm² for about 1 min to about 3,000 min. Within this range, a plating layer having a desirable cross-sectional thickness and a desirable cross-sectional thickness ratio of the copper plating layer to the nickel plating layer can be formed.

As such, the heating unit 10 including the plating layer 30 formed in at least a region on the surface of the substrate 20 by laser direct structuring can be easily formed by a person having ordinary knowledge in the art.

### MODE FOR INVENTION

Next, the present invention will be described in more detail with reference to some examples. It should be understood that these examples are provided for illustration only and are not to be construed in any way as limiting the invention.

### Example

Details of components used in Examples and Comparative Examples are as follows.

### (A) Polyaryletherketone Resin

(A1) A polyetheretherketone resin (manufacturer: Victrex, product name: 150G, melt viscosity: about 130 Pa·s) was used.

(A2) A polyetheretherketone resin (manufacturer: Victrex, product name: 450G, melt viscosity: about 350 Pa s) was used.

### (B) Additive for Direct Laser Structuring

(B1) Copper hydroxide phosphate (manufacturer: Merck Performance Materials, product name: Iriotec® 8840) was used.

(B2) Copper chromium oxide (CuCr₂O₄, manufacturer: SHEPHERD, product name: Black 1G) was used.

### Examples 1 to 3 and Comparative Examples 1 to 5

The aforementioned components were mixed in amounts as listed in Tables 1 and 2, followed by extrusion at about 380 ° C., thereby preparing a thermoplastic resin composition in pellet form. Here, extrusion was performed using a twin-screw extruder (L/D: 36, diameter: 36 mm). The prepared pellets were dried at about 100 ° C. for about 4 hours or more and then subjected to injection molding using a 10 oz. injection molding machine (molding temperature: about 400 ° C., mold temperature: about 150 ° C.), thereby preparing specimens. Next, heating unit specimens were prepared by forming a copper and/or nickel plating layer, as shown in Tables 1 and 2. Here, copper electroless plating (Examples 1 to 3, Comparative Examples 1 to 4) was performed in a copper electroless plating solution (Circuposit 4500) at about 55° C. for about 10 min to about 40 min, and nickel electroless plating (Comparative Example 5) was performed in a nickel electroless plating solution (Ronamax SMT-115) at about 50 ° C. for about 10 min to about 40 min. In addition, copper electroplating (Examples 1 to 3, Comparative Examples 1 to 4) was performed at a current density of about 10 A/dm² for about 1 min to about 3,000 min and nickel electroplating (Examples 1 to 3, Comparative Examples 2 to 5) was performed at a current density of about 5 A/dm² for about 1 min to about 3,000 min. Properties of the prepared heating unit specimens were evaluated by the following methods and results are shown in Tables 1 and 2.

### Property Evaluation

(1) Maximum temperature of plating layer: After applying a current of 20 A and a voltage of 10 V to the plating layer of the heating unit specimen prepared in each of Examples and Comparative Examples, the maximum temperature (unit: ° C.) of the plating layer was measured using a thermal imaging camera (manufacturer: FLIR, device name: T335).

(2) Warm-up time of plating layer to reach 150 ° C.: After applying a current of 20 A and a voltage of 10 V to the plating layer of the heating unit specimen prepared in each of Examples and Comparative Examples, a warm-up time (unit: second) of the plating layer to reach 150 ° C. was measured using a thermal imaging camera (manufacturer: FLIR, device name: T335).

(3) High humidity plating reliability: An injection-molded specimen having a size of 50 mm×90 mm×3.2 mm was left (for aging) at 25° C. for 6 hours, followed by activating a surface of the specimen in stripe form through laser direct structuring. Then, a copper/nickel plating layer was formed on the activated surface of the specimen under conditions as listed Tables 1 and 2, and left in a chamber under conditions of 85° C. and 85% RH for 72 hours, followed by forming 100 grids each having a size of 1 mm×1 mm on the plating layer (copper layer). Then, the number of grids remaining on the plating layer was counted upon detachment of a tape from the plating layer after attaching the tape thereto.

(4) Hot plating reliability: An injection-molded specimen having a size of 50 mm×90 mm×3.2 mm was left (for aging) at 25° C. for 6 hours, followed by activating a surface of the specimen in stripe form through laser direct structuring. Then, a copper/nickel plating layer was formed on the activated surface of the specimen under conditions as listed Tables 1 and 2, and left in a chamber at 250 ° C. for 200 hours, followed by forming 100 grids each having a size of 1 mm×1 mm on the plating layer (copper layer). Then, the number of grids remaining in the plating layer was counted upon detachment of a tape from the plating layer after attaching the tape thereto.

TABLE 1

Example

| | 1 | 2 | 3 |
|---|---|---|---|
| (A1) (parts by weight) | 100 | 100 | — |
| (A2) (parts by weight) | — | — | 100 |
| (B1) (parts by weight) | 10 | — | 10 |
| (B2) (parts by weight) | — | 10 | — |
| Cross-sectional thickness of copper | 13 | 15 | 257 |
| plating layer (μm) | | | |
| Cross-sectional thickness of nickel | 95 | 531 | 341 |
| plating layer (μm) | | | |
| Total thickness of plating layer (μm) | 108 | 546 | 598 |
| Cross-sectional thickness ratio | 1:7.3 | 1:35.4 | 1:1.3 |
| (copper:nickel) | | | |
| Maximum Temperature (° C.) | 271 | 247 | 257 |
| Time to reach 150° C. (sec) | 10 | 35 | 18 |
| High humidity plating reliability (pcs) | 97 | 96 | 98 |
| Hot plating reliability (pcs) | 98 | 95 | 97 |

TABLE 2

| | Comparative Example | | | | |
|---|---|---|---|---|---|
| | 1 | 2 | 3 | 4 | 5 |
| (Al) (parts by weight) | 100 | 100 | 100 | 100 | — |
| (A2) (parts by weight) | — | — | — | — | 100 |
| (B1) (parts by weight) | 10 | 10 | 15 | — | 10 |
| (B2) (parts by weight) | — | — | — | 10 | — |
| Cross-sectional thickness of | 1,052 | 11 | 321 | 13 | — |
| copper plating layer (μm) | | | | | |
| Cross-sectional thickness of | — | 1,096 | 258 | 51 | 431 |
| nickel plating layer (μm) | | | | | |
| Total thickness of plating layer | 1,052 | 1,107 | 579 | 64 | 431 |
| (μm) | | | | | |
| Cross-sectional thickness ratio | — | 1:99.6 | 1:0.8 | 1:3.9 | — |
| (copper:nickel) | | | | | |
| Maximum Temperature (° C.) | 163 | 174 | 184 | 211 | 231 |
| Time to reach 150° C. (sec) | 304 | 258 | 191 | 60 | 87 |
| High humidity plating reliability | 95 | 94 | 64 | 75 | 55 |
| (pcs) | | | | | |
| Hot plating reliability (pcs) | 95 | 97 | 75 | 71 | 64 |

From the results, it could be seen that the heating units according to the present invention had good properties in terms of heat generation performance (maximum temperature, time to reach 150 ° C.), high humidity/high temperature plating reliability, and the like.

Conversely, it could be seen that, in Comparative Example 1 where the nickel plating layer was not formed and the cross-sectional thickness of the plating layer exceeded the inventive range, the heating unit suffered from deterioration in heat generation performance and the like, and in Comparative Example 2 where the cross-sectional thickness of the plating layer and the cross-sectional thickness ratio of the copper plating layer to the nickel plating layer exceeded the inventive ranges, the heating unit suffered from deterioration in heat generation performance and the like. In addition, it could be seen that, in Comparative Example 3 where the cross-sectional thickness ratio of the copper plating layer to the nickel plating layer was less than the inventive range, the heating unit suffered from deterioration in heat generation performance, high humidity/high temperature plating reliability, and the like; in Comparative Example 4 where the cross-sectional thickness of the plating layer was less than the inventive range, the heating unit suffered from deterioration in high humidity/high temperature plating reliability, and the like; and in Comparative Example 5 where the copper plating layer was not formed, the heating unit suffered from deterioration in high humidity/high temperature plating reliability, and the like.

Although some embodiments have been described herein, it will be understood by those skilled in the art that various modifications, changes, and alterations can be made without departing from the spirit and scope of the invention. Therefore, it should be understood that these embodiments are provided for illustration only and are not to be construed in any way as limiting the present invention. The scope of the present invention should be defined by the appended claims rather than by the foregoing description, and the claims and equivalents thereto are intended to cover such modifications and the like as would fall within the scope of the present invention.

1. A heating unit comprising:
a substrate formed of a thermoplastic resin composition comprising about 100 parts by weight of a polyaryletherketone resin and about 1 part by weight to about 20 parts by weight of an additive for laser direct structuring; and
a plating layer formed by a laser direct structuring process and a plating process in at least a region on a surface of the substrate,
wherein the plating layer is a stack of a copper plating layer and a nickel plating layer,
the plating layer having a cross-sectional thickness of about 100 μm to about 1,000 μm, and a cross-sectional thickness ratio of the copper plating layer to the nickel plating layer in the range of about 1:1 to about 1:80.

2. The heating unit according to claim 1, wherein the polyaryletherketone resin comprises a repeat unit represented by Formula 1:

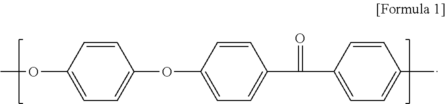

3. The heating unit according to claim 1, wherein the polyaryletherketone resin has a melt viscosity of about 50 Pa's to about 500 Pa's, as measured by a capillary viscometer at a temperature of 400 ° C. and at a shear rate of 1,000 sec⁻¹ in accordance with ASTM D3835.

4. The heating unit according to claim 1, wherein the additive for laser directed structuring comprises at least one of a heavy metal complex oxide spinel and a copper salt.

5. The heating unit according to claim 1, wherein the plating process comprises a copper electroless plating step, a copper electroplating step, and a nickel electroplating step.

6. The heating unit according to claim 1, wherein the plating process comprises a nickel electroless plating step, a nickel electroplating step, and a copper electroplating step.

7. The heating unit according to claim 1, wherein the plating layer has a maximum temperature of about 200 ° C. to about 300 ° C. upon application of a current of 20 A and a voltage of 10 V, as measured by a thermal imaging camera.

8. The heating unit according to claim 1, wherein the plating layer has a time of about 1 second to about 100 seconds to reach 150 ° C. upon application of a current of 20 A and a voltage of 10 V, as measured by a thermal imaging camera.

9. The heating unit according to claim 1, wherein the thermoplastic composition has about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber under conditions of 85° C. and 85% RH (relative humidity) for 72 hours, and forming 100 grids each having a size of 1 mm×1 mm on the plating layer.

10. The heating unit according to claim 1, wherein the thermoplastic resin composition has about 90 to about 100 grids remaining on an injection-molded specimen having a size of 50 mm×90 mm×3.2 mm, when a tape is attached to and is then detached from the specimen after leaving the specimen at 25° C. for 6 hours, activating a surface of the specimen in stripe form through laser direct structuring, forming the plating layer on the activated surface of the specimen through plating, leaving the specimen in a chamber at 250 ° C. for 200 hours, and forming 100 grids each having a size of 1 mm×1 mm on the plating layer (copper layer).

11. A method for manufacturing a heating unit, comprising:
manufacturing a substrate from a thermoplastic resin composition comprising about 100 parts by weight of a polyaryletherketone resin and about 1 part by weight to about 20 parts by weight of an additive for laser direct structuring;
irradiating at least a region on a surface of the substrate with laser beams;
performing copper or nickel electroless plating over the region irradiated with the laser beams;
performing copper or nickel electroplating over the region subjected to copper or nickel electroless plating; and
performing nickel or copper electroplating over the region subjected to copper or nickel electroplating to form a plating layer,
wherein the plating layer is a stack of a copper plating layer and a nickel plating layer,
the plating layer having a cross-sectional thickness of about 100 μm to about 1,000 μm and a cross-sectional thickness ratio of the copper plating layer to the nickel plating layer in the range of about 1:1 to about 1:80.

12. The method for manufacturing a heating unit according to claim 11, wherein the substrate is manufactured by injection molding of the thermoplastic resin composition using an injection molding machine under conditions of a molding temperature of about 380 ° C. to about 480 ° C. and a mold temperature of about 50 ° C. to about 200 ° C.

13. The method for manufacturing a heating unit according to claim 11, wherein the laser beams have a wavelength of 248 nm, 308 nm, 355 nm, 532 nm, 1,064 nm, or 10,600 nm.

14. The method for manufacturing a heating unit according to claim 11, wherein the copper electroless plating is performed in an copper electroless plating solution at a temperature of about 55° C. for about 10 min to about 40 min, and the nickel electroless plating is performed in a nickel electroless plating solution at a temperature of about 50 ° C. for about 10 min to about 40 min.

15. The method for manufacturing a heating unit according to claim 11, wherein the copper electroplating is performed at a current density of about 10 A/dm² for about 1 min to about 3,000 min, and the nickel electroplating is performed at a current density of about 5 A/dm² for about 1 min to about 3,000 min.
